(19) United States
(12) Patent Application Publication
(10) Pub. No.: US 2003/0116508 A1
(43) Pub. Date: Jun. 26, 2003

(54) Method and device for supplying filtering aids and/or process materials during filtration

(76) Inventors: Gunter Ballreich, Frickenhausen (DE); Raimund Lassak, Waldstetten (DE); Peter Rasmussen, Fredericia (DK)

Correspondence Address: GUDRUN E. HUCKETT, LONSSTR. 53, WUPPERTAL, 42289, DE

(21) Appl. No.: 10/169,301

(22) PCT Filed: Dec. 18, 2000
(86) PCT No.: PCT/EP00/12879

(30) Foreign Application Priority Data
Dec. 28, 1999 (DE) 199 63 421.1

(51) Int. Cl. B01D 35/143

(52) U.S. Cl. 210/739; 210/778; 210/85; 210/143; 210/193

(57) ABSTRACT

A device for supplying filtering aids and/or process materials during filtration is used in many applications, in particular, also in the beverage industry. Such a device comprises at least one storage container (5, 6, 7), in which the filtering aids and/or process materials are contained. Moreover, means (25, 26, 27) for metered removal from at least one storage container are provided to which is connected a suspension container (28) or mixing container. Means (44) for metered removal from the container (28) are provided. By means of sensors (48, 49) the current filtration data are measured and supplied to an electronic control unit so that, taking into consideration the current values, a metered removal of the filtering aids and/or process materials is realized.

The invention relates to a method for supplying filtering aids and/or process materials during filtration as well as a device for performing such a method.

Filtering aids and other process materials are used in many processes during filtration, in particular, in the beverage industry for filtration (separation of solid materials as well as colloidal materials from liquids). In known filtering apparatus the filtering aids and process materials are often stored in storage containers provided for this purpose and are removed therefrom as needed. The filtering aids such as diatomite and other process materials are delivered in bags which are opened and then emptied into the storage containers. Emptying of the bags requires a complex device, in particular with regard to opening of the bags, with regard to transferring the contents, as well as the required dust removal. The filtering aids are combined with a liquid in large containers in order to form a corresponding suspension which is stored in the metering container and can be supplied to the filter. Since the suspension is supplied continuously to the unfiltered material upstream of the filter, a large batch quantity of the suspension must be made available or must be continuously prepared.

The amount of filtering aids and/or process materials can thus be affected only by means of metering the quantity of water which is supplied in the form of the suspension to the filter. With this change of the metered quantity, dilution occurs and thus, for example, in connection with beer, also a change of the original gravity results which thus leads to varying beer qualities. Since the suspension with regard to its composition is present as a finished mixture, the individual components can no longer be varied so that it is not possible to react in a directed way and primarily quickly to changes in the filterability, higher sediment loading etc. (measuring the filtration data).

The object of the present invention is to provide a method for supplying filtering aids and/or process materials during filtration which can be performed more easily.

Moreover, the object resides in that a device is to be provided which is more cost-efficient.

This object is solved by a method with the features of claim 1 as well as a device with the features of claim 5.

The method according to the invention makes it possible to remove the required amount of filtering aids and/or process materials from one or more storage containers as needed, to mix them in the dry state or to suspend them and to add them subsequently to the flow of unfiltered material directly or via metering stations. The quantities (dry or liquid) taken from the storage containers are suspended in a container having a mixing device or are mixed in the dry state and are then added with constant volume flow by being metered. In this connection, a single storage container can be provided in which already a mixture of filtering aids and/or process materials is contained. In order to achieve for a simultaneous removal from different storage containers a good mixing action of the respective components, an agitator is provided in the mixing container.

It is also advantageous when the filtering aids and/or process materials, as a function of the measured filtration data, are combined with respect to quantity and composition only shortly before addition to the unfiltered material. In this way, it is possible to respond during filtration simultaneously with fixed addition amounts (stabilizing agents) as well as with variable amounts of filtering aids and/or process materials. The filtration data to be used, as a function of which metering is to be carried out and the addition of filtering aids is to be calculated, are primarily the filterability (test developed by Esser), the sediment loading (turbidity of unfiltered material, yeasts, etc.), the differential filtration pressure as well as the obtained turbidity values; they can be measured manually or automatically.

Inasmuch as a container for generating a suspension is provided, it can be embodied smaller than the batch container of known devices in which a significant amount of suspension must be at the ready. The containers now required have a volume which is only approximately 0.5% to a maximum of 10% of the currently employed conventional batch containers.

The advantage that, according to the method of the invention, the quantity of the liquid or the water supplied to the product stream or to the filter is kept constant at all times should be mentioned particularly, whereby, for example, in the case of beer, the concentration of the original wort is kept constant which, in the end, leads to a constant quality of the product. In order for the concentration of the suspension to be dependent as exclusively as possible on the respective removal amount of the individual storage containers, and not on the amount of liquid in the container, it is expedient to provide within the container a sensor for the maximum filling level which, as a function of a valve arranged within a liquid supplied line, ensures that the suspension amount removed from the container is compensated by a corresponding supply of liquid. For a metered removal of the respective suspensions or the dry mixture, the filtering aids and/or process materials are continuously supplied from the supply containers via supplying means (for example, quantity-controlled conveying screws) in a dry state or in a liquid state. The means for a metered removal are usually in the form of commercially available metering pumps.

Embodiments of the invention will be explained in the following with the aid of the drawing. The drawing shows in:

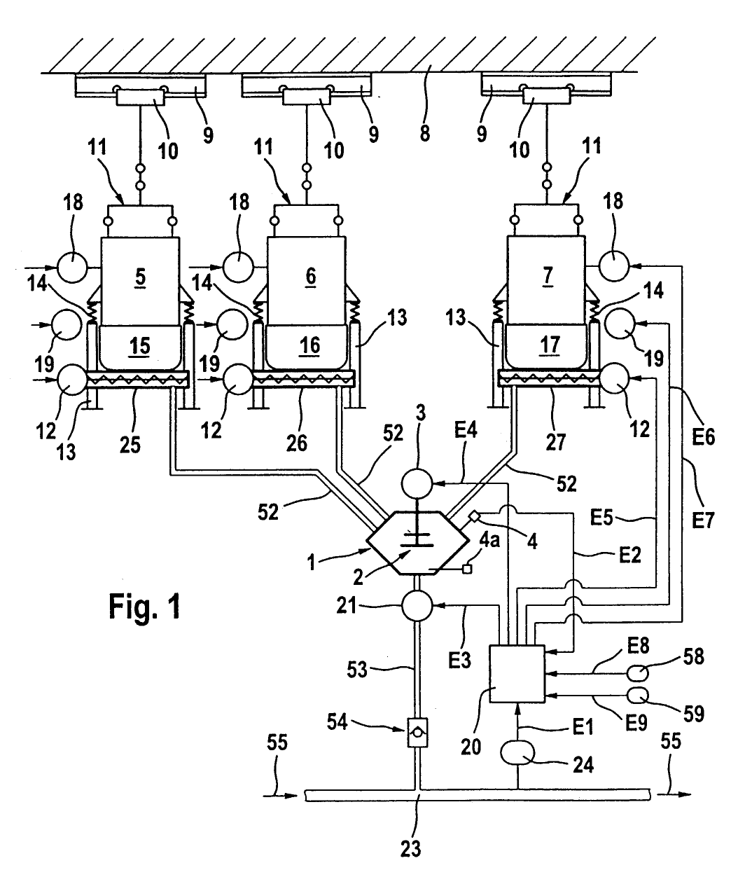

FIG. 1 a schematic illustration of a device with several storage containers and a mixing container from which the filtering aids and process materials are supplied to a product line or a metering device that is present;

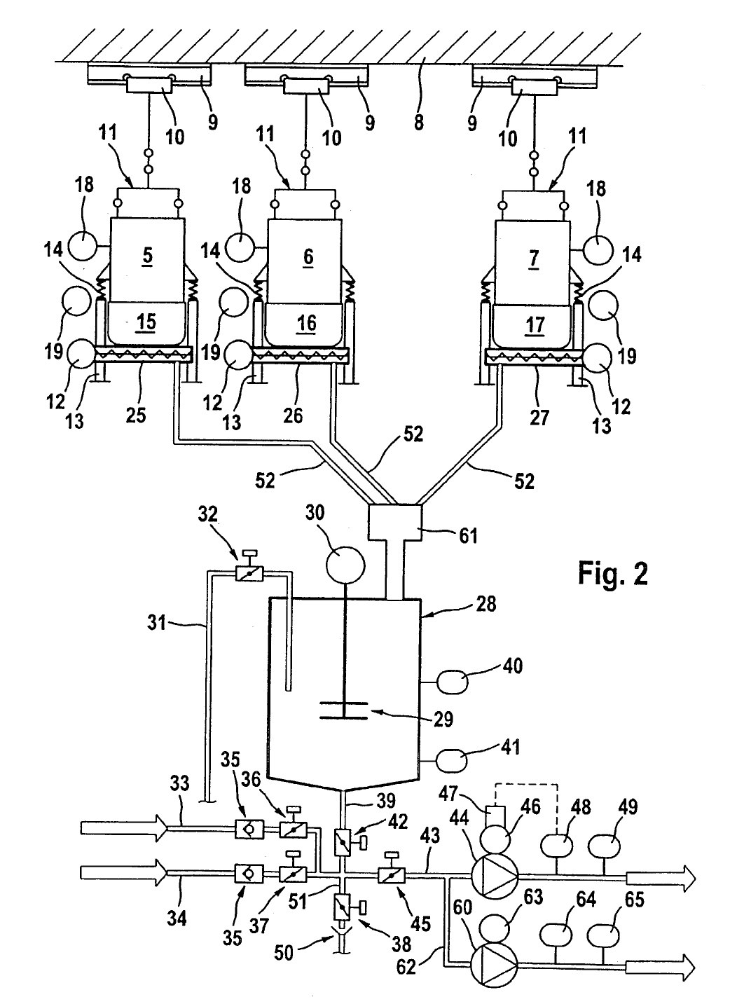

FIG. 2 an embodiment variant of the device with means for generating a suspension which supplies the suspended mixture of the filtering aids and/or process materials to a metering station that is present;

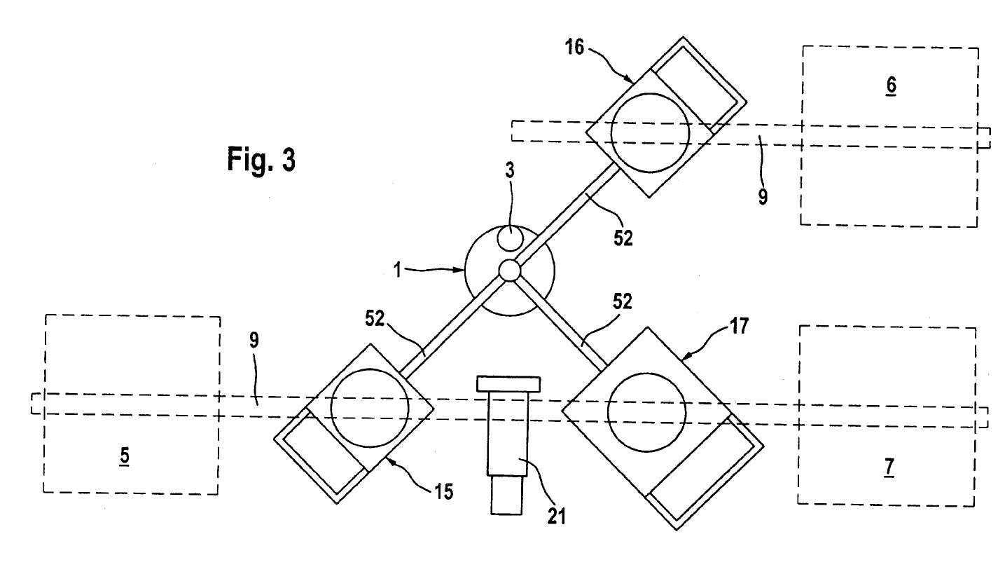

FIG. 3 a plan view onto removal devices for the storage containers and arrangement of the mixing container, wherein the device is configured for three storage containers;

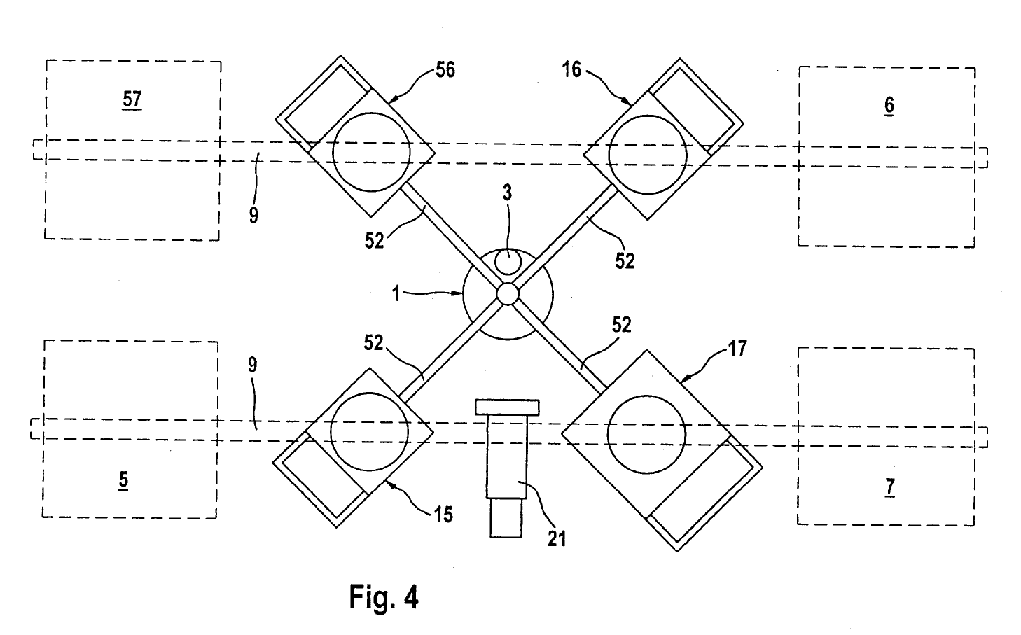

FIG. 4 an arrangement according to FIG. 3 for four storage containers.

The device in FIG. 1 which is suitable particularly for the filtration of beer, comprises three storage containers 5, 6, 7 in the form of containers, tanks, big bags or the like. By means of the example of the embodiment with big bags as storage containers 5, 6, 7, it is illustrated that they are suspended by means of a spreader 11 on a suspending device 10 (chains, lifting pulley etc.) for receiving the load and are received in a container receptacle 15, 16, 17 with their lower end that is to be opened. The suspending devices 10 are supported moveably on one or several rails 9 for changing the containers; the rails 9, in turn, are fastened on the ceiling of the building. In the area of the storage containers 5, 6, 7, a motor 18 and an additional electric motor 19 are provided, respectively. On the bottom side of the container receptacle 15, 16, 17, a metering screw 25, 26, 27 is provided, respectively, for removing the filtering aid or the process material contained in the storage containers 5, 6, 7. For each one of the metering screws 25, 26, 27, an electric motor 12 as a screw drive for driving the screw is provided; preferably, the drives are frequency-controlled electrical drives. In order to relieve the storage containers 5, 6, 7 from oscillating forces as much as possible, the big bags are supported by means of damping devices 14 on supports 13.

At the delivery ends of the conveying screws 25, 26, 27, a supply line 52 is connected, respectively, wherein the supply lines 52 lead to a mixing container 1 into which these supply lines open. An agitator 2 is arranged in the mixing container 1 and is coupled with an agitator motor 3. In the mixing container 1 a filling level sensor 4 is provided as well as a sensor 4a for indicating the empty state. At the exit side of the mixing container 1, a conveying device 21 is provided to which is connected a metering line 53. In this metering line 53 a check valve 54 is arranged which prevents that liquid flows back in the direction toward the conveying device 21 from a line 23 for the unfiltered material, into which line the metering line 53 opens.

In the line 23 for the unfiltered material, the flow direction of the product (unfiltered material) is indicated by the arrows 55. Downstream of the mouth of the metering line 53 opening into the line 23 for the unfiltered material, a sensor 24 is provided which measures one or more filtration data. The sensor 24 is connected by an electrical connecting line E1 to a control device 20. Via an electrical connecting line E2 the filling level sensor 4 is connected to the control device 20. Moreover, sensors 58 and 59 are provided in the area of a filter (not illustrated) for the product lines (unfiltered material or filtered material) and are connected by electrical connecting lines E8 and E9 to the control device 20. These sensors 58, 59 measure several filtration data, for example, the differential filtration pressure as well as turbidity values. By means of electrical connecting lines E3, E4, E5, E6 and E7, the control device 20 is connected with the electrical drives of the conveying device 21, the agitator motor 3, the screw drive 12 as well as the electric motors 18 and 19 of each storage container 5, 6 and 7.

Based on the laboratory data and/or the filtration data derived from the signals of the sensors, the respective amount of required filtering aids and/or process materials is determined in the control device 20. With corresponding signals sent via the electrical connecting lines E5 to each one of the screw drives 12 of the conveying screws 25, 26, 27, the corresponding signals are transmitted so that the respectively required amount of filtering aids or process materials is removed from the storage containers 5, 6, 7 at the container receptacle 15, 16 and 17. In this way, a metered removal of the respectively required filtering aids or process materials from the big bags is realized.

Via the supply lines 52 these filtering aids reach the mixing container 1 where they are stirred by means of the agitator 2 to a mixture as homogenous as possible. In this connection, the agitation speed can also be determined by the control device 20. Also, as a function of the values stored within the control device 20, the conveying device 21 is controlled so that the metering output is realized as a function of the product volume flow. Via the metering line 53 the filtering aids and/or process materials are supplied directly to the line 23 for the unfiltered material and in this way supplied to the filter. Such a direct supply of filtering aids into the unfiltered material without prior formation of a suspension is employed, for example, in connection with the production of proteins.

FIG. 2 shows also a device comprising three storage containers 5, 6, 7, which can be, for example, embodied in the form of big bags, and suspending devices 10 and container receptacles 15, 16, 17 which correspond to those of the illustration of FIG. 1. Also, the metering screws 25, 26, 27 together with the screw drives 12 and the supply lines 52 are of the same configuration. For reasons of simplifying the illustration, in FIG. 2 the correlation of the electronic control device 20 and the respective connections with the sensors and drives are not illustrated.

In contrast to FIG. 1, the supply lines in the embodiment of FIG. 2 lead to a chute 61 which is arranged above a container 28. In this container 28 an agitator 29 is provided which is driven by an agitator motor 30 which is arranged outside of the container 28. A liquid supply line 31 opens into the container 28 and is connected to a liquid supply line 33 or 34 and provided with a valve 32. Via the liquid supply line 31, when the valve 32 is open, a liquid can be supplied to the container 28. The container 28 comprises in the vicinity of its bottom a sensor 41 which ensures that the liquid in the container 28 will not drop below a minimal volume. In an upper area a sensor 40 for the maximum filling level is arranged within the container 28 which, when the predetermined liquid level is no longer present, will send a signal causing the valve 32 to open and causing the valve 32 to close again when the predetermined filling level is reached. At the bottom of the container 32 a container outlet line 39 is attached in which a valve 42 is arranged and which opens into a suspension line 43.

Upstream of the suspension line 43, the aforementioned liquid lines 33, 34 are provided with a check valve 35, respectively, as well as an adjustable valve 36, 37 before the liquid lines 33 and 34 combine to form the suspension line 43. In the suspension line 43, downstream of the mouth of the container outlet line 39, an adjustable valve 45 is provided and an outlet line 51 is connected to the suspension line 43 upstream of this valve 45 in the flow direction. The line 51 can be opened by means of a valve 38 into a drain 50. Downstream of the valve 45 a pump 44 is arranged in the suspension line 43 whose pump drive 46 can be affected by a rotary speed control device 47. The speed control device 47 can be affected by at least one signal of the sensors 48 and 49. The sensors 48, 49 serve for detecting, for example, the suspension flow, the suspension temperature or the like. For determining the respective amount of filtering aids and process materials in the embodiment according to FIG. 2, further filtration data are taken into account also, as has been described in connection with FIG. 1.

Between the valve 45 and the metering pump 44 a branch line 62 is connected in which a precoat pump 60 is provided having correlated therewith a drive 63. Sensors 64 and 65 can be arranged in the branch line. When the filtration operation is stopped, the metering line can be flushed with cold water in order to counteract the risk of clogging. Also, at the end of the filtration, the suspension container 28, the metering pump 44, and the metering line are cleaned with cold water as well as with hot water.

FIG. 3 shows a plan view of a group of container receptacles 15, 16, 17 correlated spatially somewhat differently and enabling with minimal space an introduction and removal of big bags 5, 6, 7 as easily as possible. The positions of the storage containers 5, 6, and 7 in the form of big bags are illustrated in FIG. 3 in dashed lines in which position they are provided with a spreader and connected to the suspending device. The dashed lines also show the rails 9 which are fastened on the ceiling of the building. The container receptacles 15, 16, 17 are arranged such that the container receptacles 15, 16 are positioned opposite one another relative to the mixing container 1 arranged at the center. In one sector between the container receptacles 15,16 the third container receptacle 17 is positioned wherein the center point of each container receptacle 15, 16, 17 is positioned at least approximately underneath one of the rails 9 so that the big bags are suspended in a position as vertical as possible for contents removal.

Each of the container receptacles 15, 16, 17 is connected by a supply line 52 with the mixing container 1 wherein according to the illustration in FIG. 3 all of these supply lines 52 open into the mixing container 1 near its center. The reference numeral 3 identifies the agitator motor 3 arranged on the mixing container 1. The storage container 5, 6, 7 can be moved from their position shown in dashed lines by means of the suspending device 10 illustrated in FIGS. 1 and 2 along the rails 9 into the area above the container receptacles 15, 16, 17. Subsequently, the big bags are opened at their side facing the container receptacles 15, 16, 17, i.e. at their bottom side, and received in the container receptacle such that a dust-free removal by means of the conveying screws arranged underneath the container receptacles is possible. In the different storage containers 5, 6, 7 or the big bags, different filtering aids (coarse, medium, and fine diatomite, perlites etc.), cellulose materials (FH 1500, Fibroklar etc.) as well as stabilizing agents (fine PVPP, silica gel, silica sol etc.) can be provided. The mixing container 1 has correlated therewith a conveying device 21 which serves for metered removal of the mixture contained in the mixing container.

FIG. 4 shows an embodiment variant of FIG. 3 in which, in comparison to the Figure described above, an additional container receptacle 56 for an additional big bag 57 is provided. For this additional big bag 57 the rail 9 is extended in the upper part of FIG. 4 to the left so that the container receptacle 56 with its center point is positioned underneath one of the rails 9. Otherwise, the other features of FIG. 4 are identical to those of FIG. 3 so that the same reference numerals are used for the same parts.

As can be taken from the above described invention, a variable mixture of the filtering aids or other process materials is carried out directly from the big bags or similar storage containers relatively shortly before being metered into the product flow. In this way, a dust-free introduction of the substances is possible. In the embodiment according to FIG. 2, the addition of the substances is realized in a water stream continuously added to the product. The adjustment of the correct filtering aid mixture or composition is carried out by employing filtration data, based on which the proportions of the respectively required amounts of the substances are determined. According to the embodiment of FIG. 1, the dry-mixed substances can also be introduced directly into the product flow.

The supply method carried out during filtration according to the invention can be used for any type of precoat filtration with metering action. Devices already in existence can be correspondingly retrofitted. In comparison to known devices and methods, a quicker and safer adaptation of the metered quantity of the filtering aids and/or process materials is possible for identical product parameters so that significant savings in regard to investment, personnel costs and operating costs as well as labor relief of the personnel can be achieved. With the device according to the invention, a high degree of automation is achieved also with a relatively minimal expenditure.

The invention can be carried out with any number of storage containers wherein in some applications a single storage container can be sufficient. It is also conceivable to provide in a storage container an already pre-mixed mixture of filtering aids and to remove it by metering.

1. Method for supplying filtering aids and/or process materials during filtration, comprising the following method steps:
measuring filtration data on a filter or of a product flow upstream and/or downstream of the filter;
calculating the required amount of respective filtering aids and/or process materials,
metered removing of dry filtering aids and/or process materials from at least one storage container (5, 6, 7, 57),
supplying a metered amount of filtering aids and/or process materials into a mixing container (19) or a suspension container (28),
mixing the filtering aids and/or process materials in the mixing container (1) or the suspension container (28),
metered removing of the filtering aids and/or process materials, in the form of a dry mixture or suspension depending on the application, from the mixing container (1) or the suspension container (28),
feeding the metered amount of mixed filtering aids and/or process materials into the product flow (unfiltered material).

2. Method according to claim 1,
characterized in that mixing of the filtering aids and/or process materials is carried out by a mixing device (2) in the mixing container (1) or a mixing device (29) in the suspension container (28).

3. Method according to one of the claims 1 or 2,
characterized in that the volume of the suspension in the container (28) is substantially maintained constant.

4. Method according to one of the claims 1 to 3,
characterized in that in one storage container a mixture of filtering aids and/or process materials is stored and a metered removal of the mixture and a dry or suspended feeding into a product flow (unfiltered material) is realized.

5. Device for supplying filtering aids and/or process materials during filtration, having the following features:
at least one storage container (5, 6, 7, 57) in which the filtering aids and/or process materials are contained,
means (25, 26, 27) for metered removal from the storage containers (5, 6, 7, 57),
a container (28) for suspending the metered removed filtering aids and/or process materials,
means (52, 61) for connecting the means (25, 26, 27) for metered removal with the suspension container (28),
means (42, 44) for metered removal of the suspension from the container (28),
means (48, 49, 58, 59) for measuring current filtration data,
an electronic control unit (20) which is connected with the means (48, 49, 58, 59) for measuring the filtration data, with the means (25, 26, 27) for metered removal from the storage containers (5, 6, 7, 57), and with the means (42, 44) for metered removal from the container (28).

6. Device for supplying filtering aids and/or process materials during filtration, having the following features:
at least one storage container (5, 6, 7, 57) in which the filtering aids and/or process materials are contained,
means (25, 26, 27) for metered removal from the at least one storage container (5, 6, 7, 57),
a mixing container (1) which is connected with the means (25, 26, 27) for metered removal;
a means (21) for metered removal from the mixing container (1),
means (48, 49, 58, 59) for measuring current filtration data,
an electronic control unit (20) which is connected with the means (48, 49, 58, 59) for measuring the filtration data and with the means (21, 25, 26, 27) for metered removal.

7. Device according to claim 5 or 6,
characterized in that at least two, preferably three, storage containers (5, 6, 7, 57) are provided.

8. Device according to claim 7,
characterized in that silos, containers, and/or tanks are provided as the storage containers.

9. Device according to claim 7,
characterized in that the storage containers (5, 6, 7, 57) are in the form of big bags which are held on a suspending device (10) and are received in a container receptacle (15, 16, 17, 56) with their open end.

10. Device according to one of the claims 5 to 9,
characterized in that a controlled conveying screw (25, 26, 27) is provided, respectively, as a means for metered removal from the storage containers (5, 6, 7, 57).

11. Device according to claim 10,
characterized in that the conveying screws (25, 26, 27) are connected by supply lines (52) with the mixing container (1) or the suspension container (28).

12. Device according to claim 6,
characterized in that in the mixing container (1) an agitator (2) is arranged which is coupled to a preferably controllable drive motor (3).

13. Device according to claim 5,
characterized in that in the container (28) an agitator (29) comprising an agitator motor (30) arranged outside of the container (28) is provided.

14. Device according to claim 12,
characterized in that on the mixing container (1) a conveying device (21) is arranged and in that a mixing device removal line (53) connected thereto opens into a product line (23) carrying the unfiltered material and is provided with a check valve (54).

15. Device according to claim 5,
characterized in that the container (28) is provided with a sensor (40) for the maximum filling level and a sensor (41) for the minimum volume.

16. Device according to one of the claims 5, 13 or 15,
characterized in that a suspension line (43) having at least one controllable valve (45) and/or a rotary speed-controlled pump (44) is arranged downstream of the container (28).

17. Device according to claim 16,
characterized in that an additional pump (60) is arranged in a branch line (62).

18. Method according to claim 1,
characterized in that a metered removal of dry filtering aids and/or process materials from several storage containers (5, 6, 7, 57) is realized.
